(19) United States
(12) Patent Application Publication
(10) Pub. No.: US 2008/0124613 A1
(43) Pub. Date: May 29, 2008

(54) Multi-functional cermet anodes for high temperature fuel cells

(76) Inventors: Turgut M. Gur, Palo Alto, CA (US); Siwen Li, Cupertino, CA (US)

Correspondence Address: LUMEN PATENT FIRM, INC., 2345 YALE STREET, SECOND FLOOR, PALO ALTO, CA, 94306, US

(21) Appl. No.: 11/975,127

(22) Filed: Oct. 16, 2007

Related U.S. Application Data
(60) Provisional application No. 60/852,336, filed on Oct. 16, 2006.

(51) Int. Cl. H01M 4/92; H01M 4/90

(52) U.S. Cl. 429/44; 429/40

(57) ABSTRACT

An anode in a Direct Carbon Fuel Cell (DCFC) is provided. The anode includes a cermet anode that can be made of nickel-copper/yttria-stabilized zirconia oxide (Ni—Cu/YSZ) or nickel-copper/gadolina-doped ceria (Ni—Cu/GDC). The surface of the cermet anode is functionalized by decorating it with dispersed catalytic particles. The particles can be made of various materials such as ruthenium (Ru), rhodium (Rh), palladium (Pd), rhenium (Re), osmium, (Os), iridium (Ir), platinum (Pt), gold (Au), or any combination of the particles' alloys and mixtures. Decorating is a process where discrete particles are deposited to the anode surface. In general the particles are not able to contact each other and have a well-defined separation. The cermet anode has a graded porous microstructure spanning from a macropore outer region to a submicron inner region, where the pore span is from tens of microns to hundreds of nanometers.

### CROSS-REFERENCE TO RELATED APPLICATIONS

This application is cross-referenced to and claims the benefit from U.S. Provisional Patent Application 60/852,336 filed Oct. 16, 2006, which is hereby incorporated by reference.

### FIELD OF THE INVENTION

The invention relates to fuel cells, and more particularly the invention relates to cermet anodes for direct carbon fuel cells, where the anodes have surfaces decorated with dispersed catalytic particles

### BACKGROUND

Development of effective and suitable materials for catalytic anodes for direct carbon fuel cells (DCFC) stands in the critical pathway for the successful commercialization these technologies. In these applications, the anode arguably presents the most demanding materials and operational requirements among other fuel cell components. It is subject to a hostile environment including high temperatures, steep gradients both in chemical and electrical potentials, severely reducing atmospheres, possible coking and sulfur poisoning, and carbon at unit activity particularly in the case of DCFC. Hence, the anode material should be a good catalyst for the oxidation of carbonaceous fuels either in gas, liquid or solid form, have sufficient chemical and thermal stability and compatibility, and possess sufficient electronic conductivity to serve as a catalytic electrode. Ultimately, of course, the anode must not lead to coking or be poisoned by sulfur and heavy metals commonly present in carbonaceous fuels such as natural gas, diesel, gasoline, coal, etc.

It is also desirable for the anode material, in general, to have the ability to accommodate sufficient concentrations of point defects, i.e., large non-stoichiometry, without undergoing phase change. Non-stoichiometry gives rise to solubility of the surface-active species in the anode material as well as facilitating fast ion transport to replenish the anode surface from the bulk. In other words, the catalytic anode serves as a sink or reservoir for the surface-active species, which is also mobile due to the large concentration of vacancies in one of the sublattices.

A typical example is the oxidation catalysts based on multicomponent defect perovskites that exhibit significant non-stoichiometry in the oxygen sublattice and fast chemical diffusion of oxide ions through the bulk by vacancy mechanism. These attributes collectively provide the catalyst surface from the bulk with a steady supply of lattice oxygen, the active species that is responsible for the rapid oxidation step. It is shown that lattice oxygen has significantly higher reactivity for oxidation reactions than molecular oxygen.

So catalytic properties of anodes are critical for the electrochemical oxidation of solid carbon based fuels at elevated temperatures. The mechanism of breaking C—C bonds in a carbon or coal particle is significantly different from breaking C—H and C—C bonds in a hydrocarbon molecule. The chemical environments at the anode are sufficiently different for the cases of gaseous hydrocarbon fuels versus solid carbonaceous fuels.

Similarly, the chemical environment of the catalyst (usually transition metals) used for coal gasification in the presence of steam is very different from the anode environment in DCFC, where only carbon oxidation to COₓ occurs.

Accordingly, for the successful commercialization of DCFC technologies, there is a critical need to develop stable anode materials and designed structures that meet the demanding catalytic requirements of high temperature fuel cells.

### SUMMARY OF THE INVENTION

To address these needs, the current invention provides an anode in a Direct Carbon Fuel Cell (DCFC), where the anode includes a cermet anode, where the surface of the cermet anode is decorated with dispersed catalytic particles. The particles can be made of various materials such as ruthenium (Ru), rhodium (Rh), palladium (Pd), rhenium (Re), osmium, (Os), iridium (Ir), platinum (Pt), gold (Au), or any combination of the particles alloys and mixtures.

In one aspect of the invention, the cermet anode can be made of nickel-copper/yttria-stabilized zirconia oxide (Ni—Cu/YSZ), nickel-copper/gadolina-doped ceria (Ni—Cu/GDC) or nickel-copper/samaria-doped ceria (Ni—Cu/SDC)

In one aspect of the invention, the particles can have a particle size within a range between 1 nanometer and 50 micrometers.

In another aspect of the invention, the dispersion of the particles can have a separation range of from 0.1 to 100 times the particle size.

In one aspect of the invention, the cermet anode has a porous microstructure.

In a further aspect of the invention, the cermet anode can be a graded porous microstructure spanning from a macropore outer region to a submicron inner region, where the span is from tens of microns to hundreds of nanometers.

In yet another aspect of the invention, the fuel cell can operate in a temperature range between 500-1200 degrees Celsius.

In one aspect of the invention, the cermet anode further comprises molybdenum (Mo) and/or its oxide incorporated therein.

### BRIEF DESCRIPTION OF THE FIGURES

The objectives and advantages of the present invention will be understood by reading the following detailed description in conjunction with the drawing, in which:

FIG. 1 shows a top planar view of cermet anode having a surface decorated with dispersed catalytic particles according to the present invention.

FIG. 2 shows side cutaway view of a porous cermet anode having a graded porous microstructure spanning from a macropore outer region to a submicron inner region according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

In the current invention, multifunctionality is introduced to cermet anodes, where the cermet anode can be made of nickel-copper/yttria-stabilized zirconia oxide (Ni—Cu/YSZ), nickel-copper/gadolina-doped ceria (Ni—Cu/GDC) or nickel-copper/samaria-doped ceria (Ni—Cu/SDC). The cermet anode surfaces are decorated with particles of ruthenium (Ru), rhodium (Rh), palladium (Pd), rhenium (Re), osmium, (Os), iridium (Ir), platinum (Pt), gold (Au), any combination of the particles alloys and mixtures or molybdenum (Mo) incorporated metal/GDC anodes. These cermet anodes are manufactured to produce a macropore surface structure, and when decorated with the above particles, yield advantages that include high catalytic activity and selectivity for carbon oxidation, catalytic spill over, sufficient oxygen non-stoichiometry, rapid oxygen chemical diffusion, a wide thermodynamic stability window to withstand reducing environments, sufficient electronic conductivity, and tolerance to sulfur and CO₂ environments. The cermet anode according to the current invention does not lead to coking or can be poisoned by sulfur and heavy metals commonly present in carbonaceous fuels such as natural gas, diesel, gasoline, coal, etc.

In general, these cermet anode materials are able to accommodate sufficient concentrations of point defects, i.e., large non-stoichiometry, without undergoing phase change, giving rise to solubility of the surface active species and facilitating fast ion transport to replenish the anode surface from the bulk material, thus serving as a sink or reservoir for the surface active species which are mobile due to the large concentration of vacancies in one of the sublattices.

Decorating is a process where discrete particles are deposited to the anode surface, where the particles are not able to contact each other in general and have a well-defined separation. For example, a decorated surface would not conduct across the surface span if the particles used as decoration were a conductive metal.

Decorating is not to be confused with doping, coating, or impregnating. Specifically, doping refers to the process of intentionally introducing impurity atoms into the crystal lattice of a material in order to change its properties. Coating is any technique for depositing a thin contiguous film of material onto the external surface of another material so as to cover its surface and isolate it from its environment. The coating layer is a generally uniform and continuous structure, where if the coating were a conductive material it would conduct across the span of the coated surface. Impregnation consists of incorporating a material into the inner pores and inner surfaces of a porous material. This is achieved by dipping of a porous support structure into a solution containing a desired catalytic agent. The solvent part of the solution is removed generally by heat treatment leaving behind the solute particles inside the pores. The agent must be applied uniformly in a predetermined quantity to a preset depth of penetration.

The current invention addresses improvement of fuel cell performance, where poor fuel cell performance is due to degradation of the cermet anode by sulfur poisoning and coke formation. The current invention provides an alloy in the Ni with a more noble metal such as Cu to reduce its activity (or chemical potential) and hence its propensity for sulfur poisoning and coking. Particularly, samaria-doped and gadolinia-doped ceria (SDC and GDC) anodes containing Cu particles for direct oxidation of hydrocarbons in DCFC reduce poisoning by sulfur. The presence of Cu serves to provide electrical conductivity through the anode. Also, Cu is a good catalyst for the activation and oxidation of carbon. Accordingly, Ni—Cu/YSZ, Ni—Cu/GDC and Ni—Cu/SDC cermet anodes or their mixtures improve performance and sulfur stability.

Decorating the surfaces of these cermet anodes with dispersed catalytic particles such as ruthenium (Ru), rhodium (Rh), palladium (Pd), rhenium (Re), osmium (Os), iridium (Ir), platinum (Pt), gold (Au), or any combination of the particles alloys and mixtures, applied by using resinates, salt solutions, nanoparticles, or inks of these metals improves their catalytic activity for carbon oxidation. They may be applied by any one of many physical and chemical methods known to those skilled in the art.

The invention includes providing multi-functionality to the cermet catalytic anode by incorporating oxides of Mo into the metal/GDC cermet anode. Oxides of molybdenum possess catalytic activity for hydrocarbon oxidation. Thermodynamic calculations at 1200K show that MoO₃ reduces to MoO₂ at P_{O2}<10⁻⁷ atm. This means that the stable oxide in the reducing atmosphere of the anode will be MoO₂, which is known to be a good electronic conductor and enhances electrode behavior. Furthermore, its sulfide (MoS₂) is also a good dehydrosulfurization catalyst.

In addition, the morphology of the anode, according to the current invention, is optimized to provide a large contact area between the anode and carbon/coal particles and also to maximize the triple phase boundaries inside the anode for the oxidation of CO, which is produced by the partial oxidation of carbon anode surface. Porous anodes preferably with graded microstructure are provided. Macropores (on the scale of tens of microns) on the outer region of the anode provide a large contact area between carbon particles and the anode surface, while the submicron pores (on the scale of tens to hundreds of nanometers) ensure the large surface area that is beneficial for the CO oxidation reaction at the anode. The porosity-graded microstructure provides ease of decorating of the catalytic particles on surfaces as well as provides direct access to the fuel without significant mass transport hindrance.

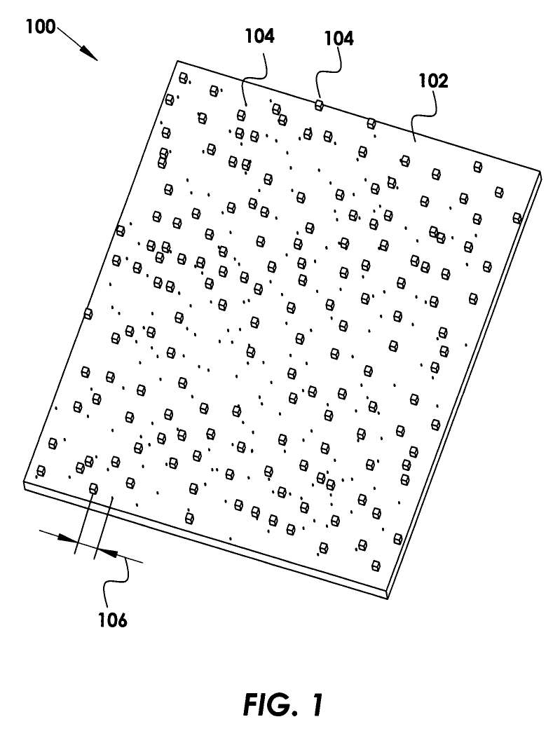

Referring to the figures, FIG. 1 shows a top planar sectional view of cermet anode 100 having a surface 102 decorated with dispersed catalytic particles 104 according to the present invention. The particles 104 can have a particle size within a range between 1 nanometer and 50 micrometers, where the particles 104 are shown not to scale for illustrative purposes. Further, the particle dispersion 106 is within a separation range of from 0.1 to 100 times the particle size.

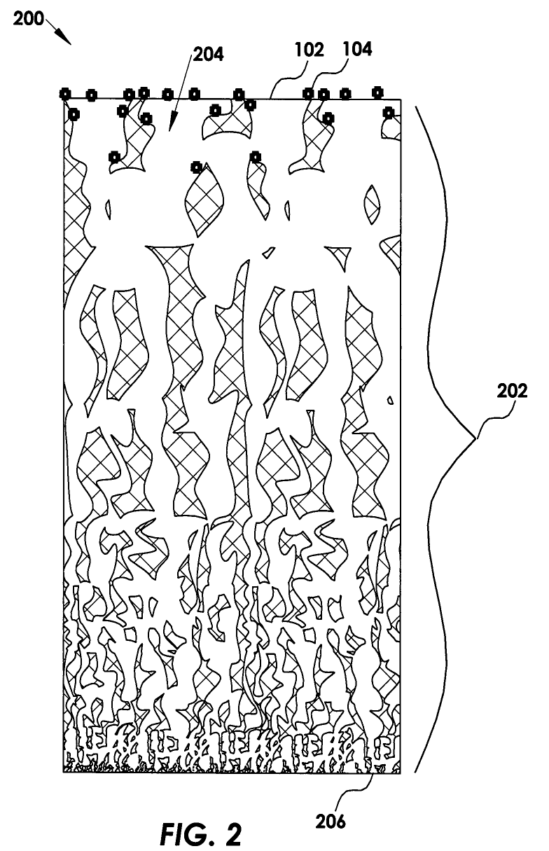

FIG. 2 shows side cutaway planar view of a porous cermet anode 200 having a graded porous microstructure. The figure shows a graded porous microstructure 202 spanning from a macropore outer region 204 to a submicron inner region 206, where the span is from tens of microns to hundreds of nanometers; the pores are shown not to scale for illustrative purposes. Also shown, the cermet anode surface 102 and portions of the macropore structure 204 are decorated with dispersed catalytic particles 104. The particles 104 decorating the anode surface 102 can be various materials such as ruthenium (Ru), rhodium (Rh), palladium (Pd), rhenium (Re), osmium, (Os), iridium (Ir), platinum (Pt), gold (Au), or any combination of the particles alloys and mixtures. The cermet anode 100 can further have molybdenum (Mo) and/or its oxide incorporated therein.

According to the current invention, the fuel cell can operate in a temperature range between 500-1200 degrees Celsius.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. An anode in a Direct Carbon Fuel Cell (DCFC), wherein said anode comprises a cermet anode, whereby only a surface of said cermet anode is decorated with dispersed catalytic particles, whereas said particles are selected from a group consisting of ruthenium (Ru), rhodium (Rh), palladium (Pd), rhenium (Re), osmium, (Os), iridium (Ir), platinum (Pt), gold (Au), and any combination of said particles alloys and mixtures.

2. The anode of claim 1, wherein said cermet anode is selected from a group consisting of nickel-copper/yttria-stabilized zirconia oxide (Ni—Cu/YSZ), nickel-copper/gadolina-doped ceria (Ni—Cu/GDC) and nickel-copper/samaria-doped ceria (Ni—Cu/SDC).

3. The anode of claim 1, wherein said particles have a particle size within a range between 1 nanometer and 50 micrometers.

4. The anode of claim 1, wherein said dispersion of said particles comprises a separation range of from 0.1 to 100 times said particle size.

5. The anode of claim 1, wherein said cermet anode comprises a porous microstructure.

6. The anode of claim 1, wherein said cermet anode comprises a graded porous microstructure spanning from a macropore outer region to a submicron inner region, whereby said span is from tens of microns to hundreds of nanometers.

7. The anode of claim 1, wherein said fuel cell operates in a temperature range between 500-1200 degrees Celsius.

8. The anode of claim 1, wherein said cermet anode further comprises molybdenum (Mo) and/or its oxide incorporated therein.
